(19) United States
(12) Patent Application Publication
(10) Pub. No.: US 2006/0033793 A1
(43) Pub. Date: Feb. 16, 2006

(54) Coupling agent patterning

(76) Inventors: Grant A. Webster, Valley Center, CA (US); Shunqiong Yue, San Diego, CA (US)

Correspondence Address: HEWLETT-PACKARD DEVELOPMENT COMPANY;Intellectual Property Administration, P.O. Box 272400, Fort Collins, CO, 80527-2400, US

(21) Appl. No.: 10/915,038

(22) Filed: Aug. 10, 2004

(51) Int. Cl. B41J 2/17

(52) U.S. Cl. 347/96

(57) ABSTRACT

A method includes ejecting a coupling agent onto a substrate. A structure includes. a substrate and a pattern of a coupling agent applied to the substrate.

### BACKGROUND

Forming structures on substrates may involve the placement of materials used to form the structures onto the substrate. In addition, material can be placed onto the substrate to assist in maintaining the position of the materials placed to form the structures. However, the materials placed to assist in maintaining the position of the materials placed to form the structures can adversely affect other structures or components on the substrate if the placement of the material to assist in maintaining the position of the materials placed to form the structures is not done in a sufficiently controlled fashion.

### BRIEF DESCRIPTION OF THE DRAWINGS

The following detailed description refers to the accompanying figures. In the figures, the left-most digit(s) of a reference number identifies the figure (Fig.) in which the reference number first appears. Moreover, the same reference numbers are used throughout the drawings to reference like features and components.

FIG. 1 is a block diagram illustrating an embodiment of a coupling agent patterning system, according to an embodiment of the present invention.

FIG. 2 is a block diagram illustrating an embodiment of a inkjet nozzle assembly that applies an exemplary coupling agent pattern, according to an embodiment of the present invention.

FIG. 3A is a diagram illustrating an exemplary pattern of deposited coupling agent droplets, according to an embodiment of the present invention.

FIG. 3B is a diagram illustrating a profile view of deposited agent droplets onto a substrate, according to an embodiment of the present invention.

FIG. 4 is a diagram illustrating a profile view of annealed droplets and application of an exemplary component, according to an embodiment.

FIG. 5 is a flowchart illustrating an exemplary process in applying coupling agents, and binding a component according to an embodiment of the present invention.

### DETAILED DESCRIPTION

Exemplary System

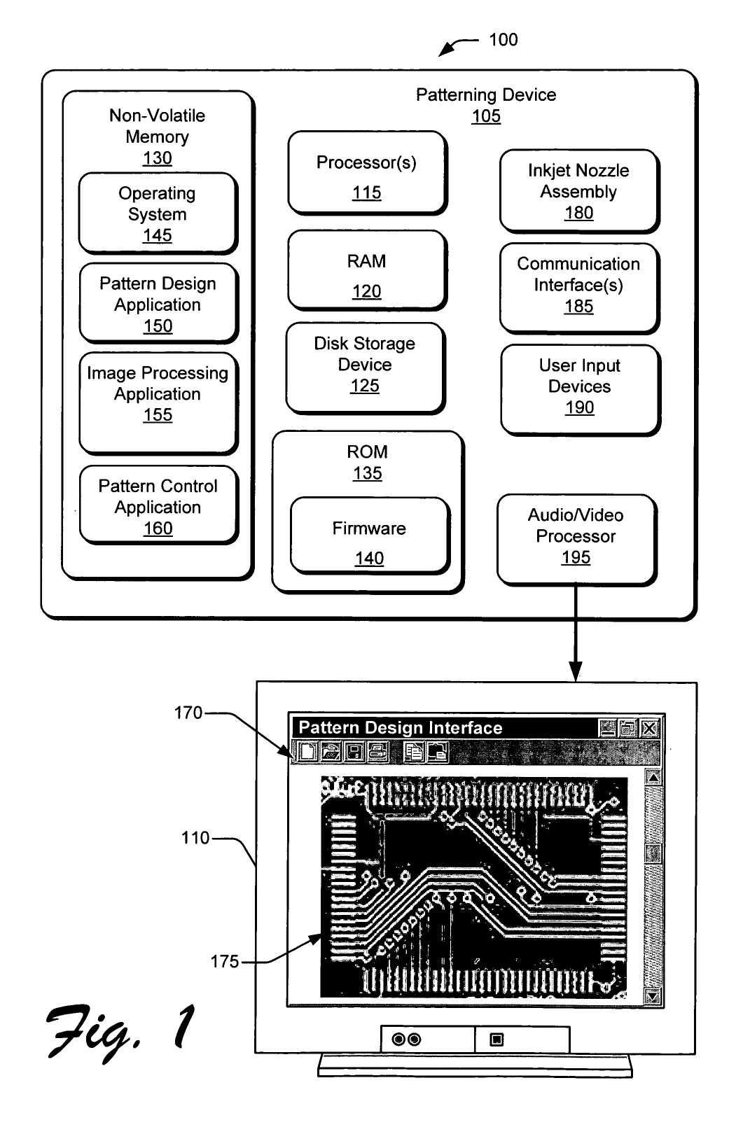

FIG. 1 shows an exemplary coupling agent patterning system 100 for performing patterning of coupling agents. The coupling agent patterning system 100 includes a patterning device 105 and a display device 110. In certain embodiments, patterning device 105 is implemented as an inkjet printer. Patterning device 105 may be a stand-alone appliance device for patterning a coupling agent onto substrates. Alternatively, the substrate patterning device 105 may be connected to a PC (personal computer) or other computing/control device.

Patterning device 105 includes one or more processors 115 (e.g., any of microprocessors, controllers, and the like) which process various instructions to control the operation of patterning device 105 and communicate with other electronic and computing devices. Patterning device 105 may be implemented with one or more memory components, examples of which include a random access memory (RAM) 120, a disc storage device 125, and non-volatile memory 130 (e.g., any one or more of a read-only memory (ROM) 135, flash memory, EPROM, EEPROM, etc.).

Disc storage device 125 may include any type of magnetic or optical storage device, such as a hard disc drive, a magnetic tape, a recordable and/or rewriteable compact disc (CD), a DVD, compact flash, and the like. The one or more memory components provide data storage mechanisms to store various information and/or data such as configuration information for patterning device 105, graphical user interface information, and any other types of information and data related to operational aspects of patterning device 105. Alternative implementations of patterning device 105 may include a range of processing and memory capabilities, and may include any number of differing memory components than those shown in FIG. 1.

Patterning device 105 may include a firmware component 140 which is implemented as a permanent memory module stored on ROM 135, or with other components in disc media marking device 105, such as a component of a processor(s) 115. Firmware 140 is programmed and distributed with substrate patterning device 105 to coordinate operations of the hardware within patterning device 105 and contains programming constructs used to perform such operations.

An operating system 145 and one or more application programs may be stored in non-volatile memory 130 and executed on processor(s) 115 to provide a runtime environment. A runtime environment facilitates extensibility of patterning device 105 by allowing various interfaces to be defined that, in turn, allow the application programs to interact with patterning device 105. In this example, the application programs include a pattern design application 150, an image processing application 155, and a pattern control application 160.

The pattern design application 150 generates a pattern design user interface 170 for display on display device 110 from which a user may create a pattern 175. Pattern 175 particularly illustrates a pattern of a coupling agent to be applied onto a substrate or medium such a circuit board. In general a coupling agent is used to bind a device or component onto a substrate or increase the binding of a device or component onto a substrate. A coupling agent may be suspended in liquid—examples include silane based coupling agents suspended in water.

The image processing application 155 processes a pattern image as represented by pattern 175 created with the pattern design user interface 170. In one embodiment, the image processing application produces a data stream of pattern image data and inkjet nozzle control data to apply (i.e., ejecting) a pattern of a coupling agent onto the substrate or medium. This data stream is formatted as inkjet control data to control the patterning device 105 in rendering (applying or ejecting) a pattern of a coupling agent onto the substrate or medium. Furthermore, the pattern image data of the data stream may include a pattern file.

The pattern control application 160 determines the location of the substrate or medium where inkjet droplets that include a coupling agent are placed, including spacing of the inkjet droplets. Inkjet droplet locations may be specified in a coordinate system such as a Cartesian coordinate system.

In one embodiment, patterning device 105 includes an inkjet nozzle assembly 180 which may be implemented to apply a pattern (as represented by pattern 175) of a coupling agent onto the substrate or medium. The inkjet nozzle assembly 180 includes one or more inkjet nozzles from which the inkjet droplets are passed through. Inkjet assembly 180 is described in further detail below.

Patterning device 105 may further include one or more communication interfaces 185 implemented as any one or more of a serial and/or parallel interface, as a wireless interface, any type of network interface, and as any other type of communication interface. A wireless interface enables substrate patterning device 105 to receive control input commands and other information from an input device, such as from a remote control device or from another infrared (IR), 802.11, Bluetooth, or similar radio frequency (RF) input device. A network interface provides a connection between substrate patterning device 105 and a data communication network which allows other electronic and computing devices coupled to a common data communication network to send label image data and other information to patterning device 105 via the network. Similarly, a serial and/or parallel interface provides a data communication path directly between patterning device 105 and another electronic or computing device.

Patterning device 105 may include user input devices 190 which may include a keyboard, pointing device, selectable controls on a user control panel, and/or other mechanisms to interact with, and to input information to substrate patterning device 105. Patterning device 105 also includes an audio/video processor 195 which generates display content for display on display device 110, and generates audio content for presentation by a presentation device, such as one or more speakers (not shown). The audio/video processor 195 may include a display controller which processes the display content to display corresponding images on display device 110. A display controller may be implemented as a graphics processor, microcontroller, integrated circuit, and/or similar video processing component to process the images. Video signals and audio signals may be communicated from disc media marking device 105 to display device 110 via an RF (radio frequency) link, S-video link, composite video link, component video link, or other similar communication link.

Although shown separately, some of the components of patterning device 105 may be implemented in an application specific integrated circuit (ASIC). Additionally, a system bus (not shown) typically connects the various components within patterning device 105. A system bus may be implemented as one or more of any of several types of bus structures, including a memory bus or memory controller, a peripheral bus, an accelerated graphics port, or a local bus using any of a variety of bus architectures. Furthermore, patterning device 105 may share a system bus with a host processor.

Exemplary Inkjet Nozzle Assembly

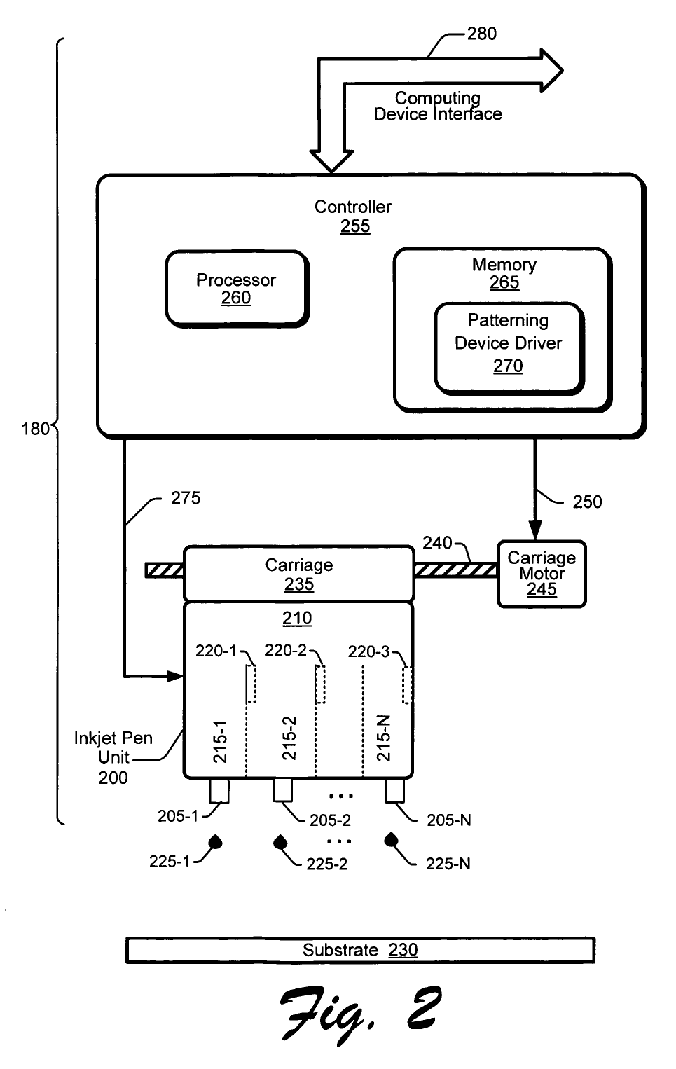

FIG. 2 shows an exemplary embodiment of the inkjet nozzle assembly 180 shown in FIG. 1. The inkjet nozzle assembly 180 includes a print head assembly or an inkjet pen unit 200. The inkjet pen unit 200 includes one or more inkjet nozzles 205. An exemplary number of inkjet nozzles 205 ranges from 300 to 600 nozzles.

A reservoir 210 contains a solution of coupling agent(s). A coupling agent is a particular adhesion promoter. In this example, coupling agent is described; however, it is contemplated that other adhesion promoters may be used. An example of an aqueous solution of a coupling agent is the following formnulation, where the percentages are by weight: approximately 0.15% γ-aminopropyl triethoxysilane (commercially available as Silquest® A1100), 5% H₂O, and the remainder (approximately 95%) ethanol. Another example formulation (percentage by weight) is approximately 1.5% γ-aminopropyl triethoxysilane, 5% 1,5-pentanediol, and the remainder H₂O. Additionally, various coupling agent solutions and various formulations will yield suitable results.

For example, components that are typically used in an inkjet fluid include humectants (organic co-solvents which help prevent evaporative loss of solvent which leads to inkjet pen failure), surfactants (organic materials containing a hydrophobic and hydrophilic functional group used to help modulate the backfill of the inkjet firing chamber), kogation control reagents (to reduce the buildup of material on top of the resistor surface in the case of thermal inkjet), and biocides (to reduce the bacterial growth that would otherwise occur within the inkjet printhead).

Examples of humectants that can be used, but not limited to, are: N-containing ketones such as 2-pyrrolidinone (2P), N-methyl-2-pyrrolidinone (NMP), 1,3-dimethylimidazolid-2-one, and octylpyrrolidinone; diols such as ethanediols (e.g., 1,2-ethanediol), propanediols (e.g., 1,2-propanediol, 1,3-propanediol), butanediols (e.g., 1,2-butanediol, 1,3-butanediol, 1,4-butanediol), pentanediols (e.g., 1,2-pentanediol, 1,5-pentanediol), hexanediols (e.g., 1,2-hexanediol, 1,6-hexanediol), heptanediols (e.g., 1,2-heptanediol, 1,7-heptanediol), octanediols (1,2-octanediol, 1,8-octanediol); triols such as 2-ethyl-2-hydroxymethyl-1,3-propanediol and ethyl hydroxypropanediol (EHPD); and glycol ethers and thioglycol ethers. These ethers can include polyalkylene glycols such as polyethylene glycols (e.g., diethylene glycol (DEG), triethylene glycols, tetraethylene glycols), polypropylene glycols (e.g., dipropylene glycol, tripropylene glycol, tetrapropylene glycol), polymeric glycols (e.g., PEG 200, PEG 300, PEG 400, PPG 400) and thioglycol. Preferably 2P, NMP, DEC, EHPD and 1,5-pentanediol are employed in this practice with 2P, DEG, and 1,5-pentadiol being the most preferred.

Suitable surfactants may be nonionic, cationic, or anionic when used in the fluid vehicle. Examples of suitable nonionic surfactants include, secondary alcohol ethoxylates (e.g., Tergitol® series available from the Union Carbide Co.), nonionic fluorosurfactants (e.g., FC-170C® available from the 3M Co.), nonionic fatty acid ethoxylate surfactants (e.g., Alkamul® PSMO-20 available from the Rhone-Poulenc Co.), fatty amide ethoxylate surfactants (e.g., Aldamide® L-203 from the Rhone-Poulenc Co.), and acetylenic polyethylene oxide surfactants (e.g., Surfynol® series available from Air Products & Chemicals, Inc.). Examples of anionic surfactants include alkyl diphenyl oxide surfactants (e.g., Calfax® available from the Pilot Co. and Dowfax® 8390 from the Dow Co.), and fluorinated surfactants (e.g., Fluorad® series available from the 3M Co.). Cationic surfactants that may be used include betaines (e.g., Hartofol® CB-45 available from Hart Product Corp., Mackam® OCT-50 available from McIntyre Group Ltd., Amisoft® series available from the Ajinomoto Co.), quaternary ammonium compounds (e.g., Glucquat® series available from the Amerchol Co.; Bardac® and Barquat® series available from the Lonza Co.), cationic amine oxides (e.g., Rhodamox® series available from the Rhone-Poulenc Co.; and Barlox® series available from the Lonza Co.), and imidazoline surfactants (e.g., Miramine® series available from the Rhone-Poulenc Co.; and Unamine® series available from the Lonza Co.).

A variety of the biocides may be used, such as NUOSEPT® 95 (available from Hals America Co.), Proxel® GXL (available from the Avecia Co.), and glutaraldehyde (available from the Union Carbide Co. under the tradename UCARCIDE® 250).

Finally, examples of anti-kogation reagents that may be used in conjuction with the disclosed embodiments include: trisodium phosphate (Na₃PO₄), potassium phosphate (K₃PO₄), ammonium nitrate (NH₄NO₃) and phytic acid (available from the Aldrich Co.).

In this example, reservoir 210 provides aqueous coupling agent solution to sub-reservoirs 215. Sub-reservoirs 215 provide coupling agent solution to particular nozzles 205. Heating elements 220 are provided to create “bubbles” in reservoirs 215. Specifically, when heating elements 220 are activated, they heat the coupling agent solution in reservoirs 215 and create bubbles. When a bubble is created in a particular reservoir 215, coupling agent solution is forced through the corresponding nozzle 205. This results in coupling agent droplets 225. Coupling agent droplets 225 may have an exemplary volume of 6 to 10 picoliters. Couplinrg agent droplets 225 are deposited in a pattern onto a substrate 230. Substrate 230 may be composed of various materials such as silicon glass and lower cost substrates such as plastics. The same results may be achieved using techniques other than the exemplary thermal bubble technique described. Other techniques include, but are not limited to, piezoelectric inkjet techniques.

Inkjet pen unit 200 is physically mounted on a carriage 235 that is moved along a spindle 240. A carriage motor 245, which may be implemented as a stepper motor, moves carriage 235 back and forth at various locations of substrate 230. This allows inkjet pen unit 200 and nozzles 205 to place droplets 225 at particular locations of substrate 230 and form a pattern.

The carriage motor 245 is calibrated to move to particular positions by receiving a corresponding input signal 250 from a controller 255. Controller 255 may receive the pattern file described above in FIG. 2 which is parsed by the controller 255 to control a patterning mechanism as represented by carriage motor 245 and carriage 235.

In some embodiments, controller 255 may be implemented as a printed circuit board employing a combination of various components discussed above with respect to the coupling agent patterning system 100 of FIG. 1. Accordingly, controller 255 may include a processor 260 for processing computer/processor-executable instructions from various components stored in a memory 265. Processor 260 may be one or more of the processors 115 discussed above with respect to the coupling agent patterning system 100 of FIG. 1. Likewise, memory 265 may be the non-volatile memory 130 and/or firmware 140 of coupling agent patterning system 100 of FIG. 1.

A patterning device driver 270 may be further stored in memory 265 and executable on processor 260. Patterning device driver 270 particularly controls the activation of heating elements 220 and firing of coupling agent solution from nozzles 205. An electrical input 275 may be provided to particularly heating elements as instructed by patterning device driver 270.

Computing device interface 280 interfaces the controller 255 of the inkjet nozzle assembly 175 with another electronic or computing device to receive pattern image data. The computing device interface 280 can be implemented as an ATAPI (Advanced Technology Attachment Packet Interface), which is one of many small computer parallel or serial device interfaces. Another computer interface that could be implemented for computing device interface 280 is SCSI (small computer system interface), which is a generalized device interface for attaching peripheral devices to computers. Various other physical interfaces that may be used include the Parallel Interface, Fiber Channel, IEEE 1394, USB (Universal Serial Bus), and ATA/ATAPI.

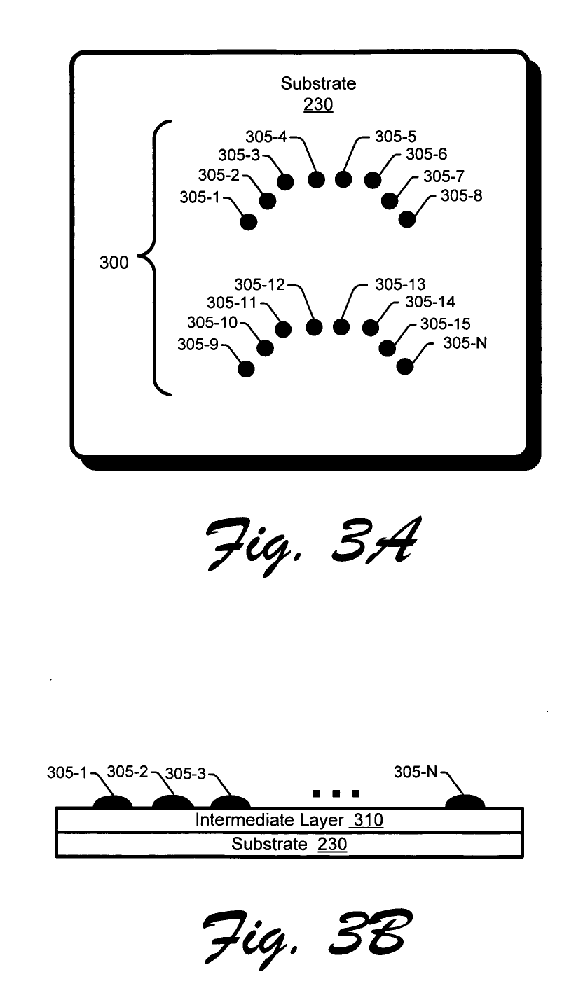

FIG. 3A shows an exemplary pattern 300 of deposited coupling agent droplets. Pattern 300 is an approximate physical representation of two circuit traces of pattern 175 as shown in FIG. 1. Pattern 300 may be applied to avoid coupling agent contamination of pre-existing components or devices on substrate 300.

Pattern 300 is made up of droplets 305 applied onto substrate 230. Each of the droplets 305 may have a width of approximately 10-30 microns when applied onto substrate 230. In some embodiments, patterning system 100 may be configured, through use of various print modes using different print masks, to apply a desired thickness, such as 1 or 2 mono-layers in one embodiment, of coupling the agent onto substrate 230. When applying droplets 305, in order to dissipate excess fluid (i.e., liquid used to suspend a coupling agent) it may be desirable to operate (i.e., apply pattern 300) at temperatures elevated from normal temperatures (i.e., normal temperature being when the aqueous solution is stable; stable being negligible evaporation or dissipation of solution used to suspend a coupling agent). Examples of such elevated temperatures approximately range from 120 to 150 degrees centigrade. Operation at such elevated temperatures further provides for smaller widths of droplets 305.

FIG. 3B shows a profile view of droplets 305 applied onto substrate 230. In certain cases, an intermediate layer 310 may be used and placed between substrate 230 and droplets 305. Intermediate layer 310 may be a binding layer which is enhanced by the application of a coupling agent in droplets 305. Droplets 305 may or may not touch one another when applied.

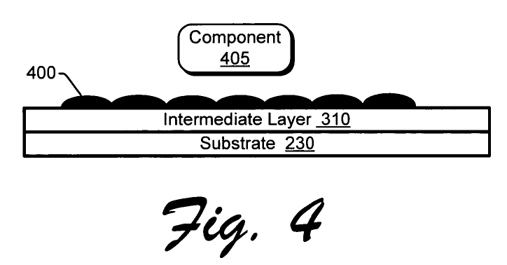

FIG. 4 shows a profile view of annealed droplets and application of a component. In this example, component 405 is effectively applied to substrate 230 by intermediate layer 310 acting as a binding layer and coupling agent layer 400. Coupling agent layer 400 includes droplets 305 which may be annealed. Such annealing process may be performed by heating or by rolling the droplets 305 to form coupling agent layer 400.

Process To Apply Coupling Agent

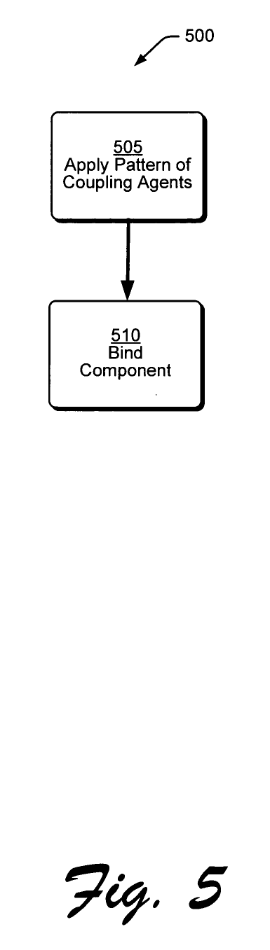

FIG. 5 shows an exemplary process 500 to apply a coupling agent and bind a component.

At block 505, a pattern is applied to a substrate such as substrate 230, either directly or on a binding layer such as intermediate layer 310. The pattern is particularly defined to avoid contamination of pre-existing components or devices on the substrate. Pattern 300 described in FIG. 3 is an example of such a pattern. The pattern is applied using inkjet technologies as described in FIGS. 1 and 2 (e.g., patterning device 105). The pattern includes a number of applied coupling agent droplets that as described above are made up of a coupling agent suspended in an aqueous solution. Block 505 may be performed at normal room temperature (i.e., temperature where the aqueous solution remains stable), or elevated temperatures.

Once the droplets are set (i.e., cured) either by waiting for a set time or annealing, at block 510 the applied coupling agent may be used to bind a particular component or device directly or indirectly (i.e., use of an intermediate binding layer) to a substrate.

Although embodiments have been described in language specific to structural features and/or methodological acts, it is to be understood that the claimed subject matter is not necessarily limited to the specific features or acts described. Rather, the specific features and acts are disclosed as exemplary forms of implementing the claimed subject matter.

1. A device comprising:
a processor;
memory to store a patterning application executable on the processor; and
an inkjet nozzle assembly implemented to apply a pattern of a coupling agent onto a substrate as instructed by the processor.

2. The device of claim 1 wherein the inkjet nozzle assembly comprises a reservoir containing an aqueous solution of the coupling agent.

3. The device of claim 1 wherein the coupling agents are applied as droplets onto the substrate.

4. The device of claim 1 wherein the device is an inkjet printer.

5. A method comprising:
ejecting a coupling agent onto a substrate; and
curing the coupling agent.

6. The method of claim 5 wherein the ejecting forms a pattern of the coupling agent on the substrate.

7. The method of claim 5 wherein the coupling agent is chosen from a group of adhesion promoters.

8. The method of claim 5 wherein the coupling agent is chosen from a silane group.

9. The method of claim 5 wherein the coupling agent is suspended in an aqueous solution, and the ejecting is performed at temperatures greater than temperatures at which the aqueous solution is stable.

10. The method of claim 9 wherein the temperature is chosen from the range of 120 to 150 degrees centigrade.

11. The method of claim 5 further comprising binding a component onto the coupling agent.

12. A method, comprising:
step for depositing a coupling agent onto a substrate; and
step for treating the coupling agent.

13. The method of claim 12 further comprising step for attaching a component onto the coupling agent.

14. A structure comprising:
a substrate;
a layer of coupling agent defining a pattern on the substrate; and
a component bound to the layer of coupling agent.

15. The structure of claim 14 wherein the layer of coupling agent is applied by an inkjet nozzle assembly.

16. The structure of claim 14 further comprising a binding layer between the substrate and the layer of coupling agent.

17. A patterning device comprising:
means for forming a pattern of a coupling agent on a substrate; and
means for binding a component onto the pattern.

18. The patterning device of claim 17 further comprising means for annealing the pattern of a coupling agent.

19. A structure, comprising:
a substrate;
a pattern of a coupling agent applied to the substrate by an inkjet assembly; and
a component bound to the pattern.

20. The structure of claim 19 wherein the pattern of coupling agent is applied by an inkjet nozzle assembly.

21. The structure of claim 1 further comprising a binding layer between the substrate and the pattern of coupling agent.
